(19) United States
(12) Patent Application Publication
(10) Pub. No.: US 2006/0076544 A1
(43) Pub. Date: Apr. 13, 2006

(54) Safety sign/barrier

(76) Inventor: William M. Kurple, St. Charles, MO (US)

Correspondence Address: Robert L. Villhard;Thompson Coburn LLP, Suite 3500, One US Bank Plaza, St. Louis, MO, 63101-9928, US

(21) Appl. No.: 10/962,644

(22) Filed: Oct. 12, 2004

(51) Int. Cl. A01K 3/00

(52) U.S. Cl. 256/26

(57) ABSTRACT

A safety sign/barrier functions as a safety sign and as an access control barrier. The sign/barrier has an expandable fence member, a support, and a message display surface. The fence member has a variable length between its proximal and distal ends and expands and contracts along the length. The support includes two portions each of which are connected to an end of the fence member. The support is adapted to maintain the barrier in an upright, stable orientation when the fence member is contracted. Another embodiment provides a sign including a display surface and an expandable fence member. The display surface is either parallel to or at an acute angle relative to the expandable fence member. Methods of controlling access with a sign including an expandable fence and displaying messages on an access control barrier are also provided.

### BACKGROUND OF THE INVENTION

1. Field of the Invention

This invention relates generally to safety signs and access control barriers. More particularly, the present invention pertains to safety signs capable of use as access control barriers and pertains to access control barriers capable of use as safety signs.

2. Description of the Prior Art

It is often desirable to alert pedestrians to conditions caused by floor maintenance. For instance, while a waxed floor is drying people that tread on the floor will mar the uniform coating if they do not detour around the treated area. Custodians will typically place a self-standing sign on the floor with an appropriate message for passers-by alerting them to the need to stay off of the wet floor. Signs in common use include messages such as “Wet Floor,” “Detour,” and “Area Closed For Cleaning.”

Use of safety signs, though, is not limited to janitorial situations. Construction activities frequently make it desirable to post a sign alerting traffic to conditions caused by the construction (e.g. a detour). Likewise, law enforcement and other emergency respondents frequently need to cordon off areas for temporary access control. Moreover, entertainment events (or any gathering where large numbers of attendees may be unfamiliar with their surroundings) often create the need to provide pedestrians and other traffic with messages directing them to their destination. All of these applications, and others, call for the use of self-standing signs and barriers to direct individuals to, or away from, particular areas.

One type of sign that is particularly well suited to conveying messages to those passing by is known as a “cone-shaped” sign. Cone-shaped signs usually include four nearly vertical surfaces for displaying messages. The surfaces are inclined slightly so that those viewing the sign from above (e.g. pedestrians standing near or over the sign) can still view the messages displayed thereon. The inclined surfaces angle inwardly toward one another as they extend upwardly and form a square “cone” that is stable enough to stand on its own. Thus, sign users have found that these “cone-shaped” signs are convenient message display devices. However, the cone-shaped signs do not present a barrier to traffic. Because the signs occupy only a small space, people can move freely around the sign without regard for the messages displayed thereon.

As a result, a person wishing to control access to an area generally must erect a barrier to supplement the sign. While barriers are available which expand from a compact storage configuration to a width suitable for use as a barrier, the bases of these barriers are often too small to maintain the barrier in a stable, upright configuration when the barriers are in their compact storage configuration. Because these barriers are designed to minimize the required storage space for the barrier, the barriers contract into flat, relatively thin configurations for storage. Accordingly, even if these barriers could stand upright on their own when contracted for storage, the compact designs of the barriers present a minimized set of surfaces for displaying messages.

In an attempt to overcome these problems some barriers have provisions to hang a separate sign on the barrier. However, these signs can be become separated from the barrier thereby necessitating additional time and labor to find and place the sign on the barrier. Taking into account these problems these barriers are therefore poorly suited for displaying messages.

Thus, a need exists for a device that will allow a user to either display messages, control access to an area, or both with one device.

### SUMMARY OF THE INVENTION

It is in view of the above problems that the present invention was developed. The invention provides signs that can expand to create barriers, and barriers that can contract to form signs.

In a first preferred embodiment, the present invention provides an expandable barrier that includes an expandable fence member, a support, and a message display surface. The fence member has a length between its proximal and distal ends, and the fence member length expands and contracts. The support includes two portions of the support that are each connected to opposite ends of the fence member. The support portions are adapted to maintain the barrier in an upright, stable orientation when the fence member is in its contracted position. With regard to the orientation of the display surface, select display surfaces may be parallel to the expandable fence member. Other display surfaces can be perpendicular to the fence member while other display surfaces can form an acute angle with respect to the expandable fence member. Further, the display surface may be bi-furcated with a first portion of the display surface being on the first portion of the support and a second portion of the display surface being on the second portion of the support. For applications where the barrier may also be used as a sign, the first and the second portions of the support may form a cone-shaped sign when the expandable fence member is in its contracted position. In another embodiment that is particularly well suited for use as a sign, the barrier may include four display surfaces that form a cone-shaped sign when the fence member is in its contracted position.

A second preferred embodiment provides a sign including a display surface and an expandable fence member. The display surface is either parallel to, or at an acute angle relative to, the expandable fence member. A support may also be included that has a first portion and a second portion. Each of the support portions may include a portion of the display surface and each support portion connects to an end of the expandable fence member. Even in applications in which the support is divided into portions, the support maintains the fence in a stable, upright position when the expandable fence member is in its contracted position. Furthermore, the support can form a cone-shaped sign when the expandable fence member is in its contracted position. The sign may also include a second display surface that is perpendicular to the expandable fence member.

In another preferred embodiment, the present invention provides a method of controlling access to an area. The method includes contracting an expandable fence member, displaying a message on a display surface that is coupled to the fence member, and maintaining the fence member in a stable, upright orientation. To maintain the stable, upright orientation of the barrier, a first portion and a second portion of a support are used. The first portion of the support is connected to the expandable fence member at the proximal end and the second portion of the support is connected at the distal end. While the expandable fence member is being contracted, a cone-shaped sign may be formed from the first and the second portions of the support.

In yet another preferred embodiment, the present invention provides a method of displaying a message. The method of this embodiment includes contracting an expandable fence member and displaying a message on a display surface coupled to the expandable fence member. The display surface is parallel to (or at an acute angle relative to) the expandable fence member. Where four display surfaces are coupled to the expandable fence member to display messages, the four display surfaces may be formed into a cone-shaped sign during the contraction of the expandable fence member.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates a cone-shaped sign constructed in accordance with a preferred embodiment of the present invention;

FIG. 2 illustrates an access barrier constructed in accordance with another preferred embodiment of the present invention;

FIG. 3 illustrates a cone-shaped sign in accordance with another preferred embodiment of the present invention; and

FIG. 4 illustrates an access barrier in accordance with yet another preferred embodiment of the present invention.

### DETAILED DESCRIPTION OF THE PREFERRED EMBODIMENTS

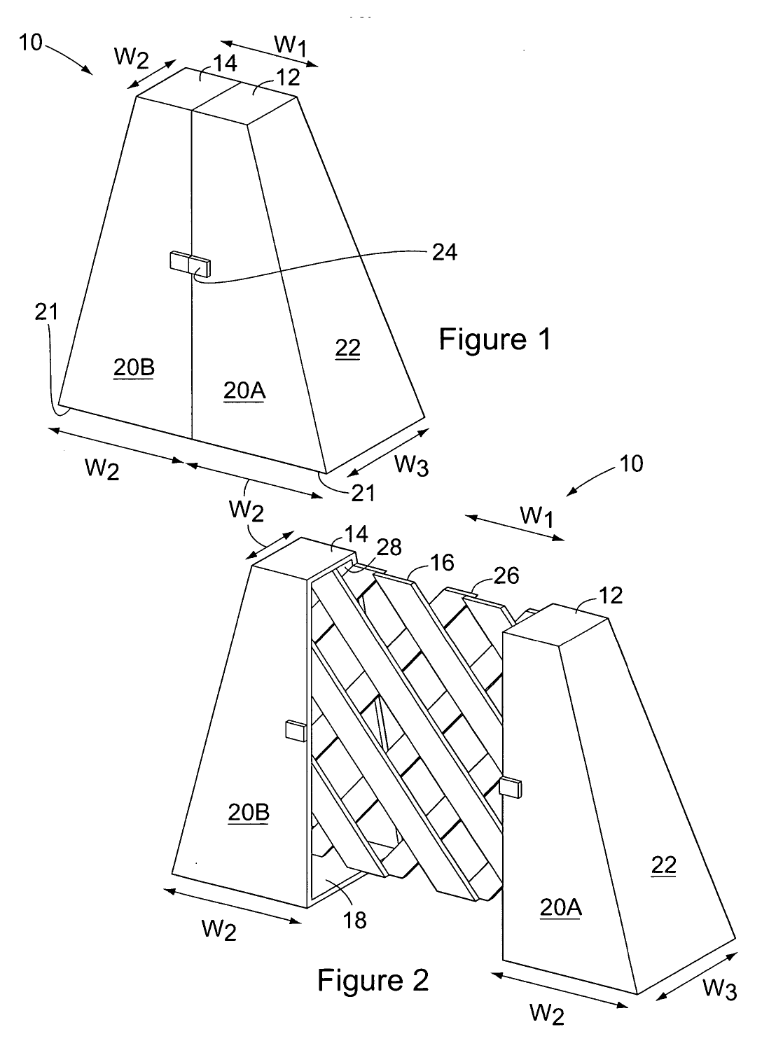

Referring to the accompanying drawings in which like reference numbers indicate like elements, FIG. 1 and FIG. 2 illustrate a cone-shaped sign constructed in accordance with the principals of the present invention. Generally, FIG. 1 shows the sign 10 in a closed position while FIG. 2 shows the sign 10 in an open position in which the sign 10 creates a barrier.

FIG. 2 also shows that the sign 10 includes a first sign portion 12, a second sign portion 14, an expandable fence 16, an interior volume 18, and display surfaces 20A, 20B and 22. The portions 12 and 14 (e.g. halves) of the sign 10 are shown in FIG. 1 as abutting each other (to form the cone-shaped sign 10) and being held together by a latch 24 or other retaining device. The halves 12 and 14 of the sign 10 connect to the opposite ends 26 and 28 of the expandable fence 16. Thus, when the expandable fence 16 is in its fully expanded position the halves 12 and 14 of the sign 10 are spaced apart by the fully expanded width (w1) of the fence 16. When the expandable fence 16 is in its fully contracted position (FIG. 1), the halves 12 and 14 contain the expandable fence 16 in the internal volume 18. The expandable fence 16 shown is a folding lattice type fence, although any type of expandable fence 16 will work well according to the principles of the present invention. Other illustrative types of fences 16 include, but are not limited to, a telescoping fence, a roll-up fence, a scissors mechanism fence, an accordion fold (i.e. z-fold) fence, a cloth belt fence (such as those used to control crowds in theaters), and other equivalent fences. Thus, the sign 10 may be employed to display messages on the display surfaces 20A, 20B and 22 and/or may be used as an access control barrier as desired by the user. While the current embodiment includes portions 12 and 14 that form a cone shaped sign, when the expandable fence 16 is in its contracted position, the present invention also provides signs of other shapes. For instance, another preferred embodiment includes a sign with two portions that form a square base member supporting an inverted cone (with the wide end up) when the expandable fence is in its contracted position.

With reference again to FIGS. 1 and 2, when the expandable fence member 16 is in its contracted position, the sign 10 (i.e. the sign portions 12 and 14) can be said to be in a closed position. In contrast, when the expandable fence member 16 is in its expanded position, the sign 10 can be referred to as being “open.” Of course, the expandable fence 16 can be positioned anywhere between its fully contracted and its fully expanded position with the sign 10 being in a corresponding intermediate position. When closed, the primary use of the sign 10 is for displaying messages on the surfaces 20 and 22 in a manner similar to the way that messages are conveyed with conventional cone-shaped signs. If the sign 10 is partially (or completely) open it can be used to display messages and as an access control barrier too. Of course, there is no need per se to display messages on the surface 20 and 22 when using the sign 10 as a barrier. Though, in practice it has been found that displaying messages on the barrier 10 is preferred. It will also be appreciated by those skilled in the art that because the fence member 16 is expandable, the user can adjust the width (w1) of the barrier created by the sign 10.

Several features of the exemplary sign 10 facilitate the dual uses of the sign/barrier 10. For instance, the display surface includes portions 20A and 20B on the halves 12 and 14 of the sign 10 respectively. The display surface portions 20A and 20B are shown being substantially parallel to, and offset from, the face of the expandable fence 16. Different messages may be displayed on the surface portions 20A and 20B. For example, a right pointing arrow can be displayed on one portion 20A and a left pointing arrow displayed on the other portion 20B. Such an exemplary sign 10 can be used as a barrier to direct traffic around an obstacle that lies in the middle of a traffic area (e.g. an open manhole in a street or sidewalk). In the alternative, the same message can be displayed on the portions 20A and 20B as where up pointing arrows direct traffic to proceed into lanes marked by the closed sign 10. Of course, one message may span both surface portions 20A and 20B as with a conventional cone-shaped sign. On the other hand, the display surface could include a member upon which the user can write (or otherwise place) a message on the sign 10 as well as erasing (or removing) the message too. Or the sign 10 could incorporate replaceable display panels so that the user can select the messages to be displayed. Such selectable display panels are describe in the co-owned, co-pending U.S. patent application Ser. No. 10/803,839, entitled Multi-Use Floor Sign, filed Mar. 18, 2004 which is incorporated herein as if set forth in full. Of course, the fence member 16 can also be used to display messages.

The base 21 of each surface portion 20A and 20B is preferably large enough that the weight of the fence 16 (when fully expanded) cannot tip the portions 12 and 14 over. Accordingly, for any given application the weight (or type) of the fence 16 and the width w2 of the surface portion 20A may be chosen so as to cooperate to create a stable sign 10. In other words, the width (w2) is chosen to counteract the moment created by the weight of the fence 16 acting on the portion 12, thereby maintaining the sign 10 in a stable, upright orientation. As a result, the portions 12 and 14 of the sign 10 act as a stand of the barrier created by the expandable fence member 16. Of course, it is possible to include additional stabilizing means (such as suction cups) to the bottom of one, or more, of the portions 12 and 14 to provide additional stability for the sign 10.

In the alternative, the expandable fence 16 can be of a relatively rigid construction with rigid connections between the portions 12 and 14 and the expandable fence member 16. Thus, the width (w2) of the surface portion 20A can be reduced without regarding to tipping (when the sign 10 is open) because the rigid construction makes the stability of a single portion 12 or 14 moot. However, large widths (w2) of the surface portions 20A or 20B are preferred because wide surface portions 20A and 20B allow a larger message to be displayed on the portions 20A or 20B when the sign 10 is open. Plus, one pair of sign halves 12 and 14 can be connected to any type of expandable fence 16 without the weight of the fence 16 causing either sign portion 12 or 14 to tip over if the width (w2) is chosen to accommodate the heaviest expandable fence member 16 that is to be connected to the sign portions 12 and 14 (regardless of whether the fence member is in its expanded, contracted, or some intermediate position).

Similarly, the width (w3) of surface 22 may be chosen to prevent environmental disturbances (e.g. wind gusts or incidental collisions) from tipping the sign 10 over while allowing sufficient area to display appropriate messages. In a preferred embodiment, the widths (w2) and (w3) are about the same. In another preferred embodiment, the width (w3) is twice the width (w2) so that a closed sign 10 appears to be a conventional cone-shape sign. As to the height of the sign 10, the sign 10 is preferably about knee or hip high on the average person for signs 10 used to display messages to pedestrian traffic. If the targeted traffic is vehicular, then signs 10 that are at least about shoulder high are preferred. Display surfaces 20A, 20B and 22 with a wide variety of aspect ratios (i.e. the height divided by the width) are therefore provided by the present invention

The orientation of the display surfaces 20A, 20B and 22 relative to the expandable fence member 16 also facilitates the dual use capability of the sign/barrier 10. As shown by FIG. 2, the display surface 22 can be perpendicular to the fence member 16, although it can also be positioned at an acute angle with respect to the fence member 16. Perpendicular display surfaces 22 are preferred over angled display surfaces 22 so that traffic approaching the sign 10 from the side can view the messages displayed thereon. It is also preferred for the display surface 20A and 20B to be offset from the expandable fence member 16 by at least a portion of the width (w3) (of the display surface 22) so that traffic may view the display surface 20A and 20B even when the sign 10 is closed. More particularly, it is preferred for the display surface 20A and 20B and the expandable fence member 16 to be offset by about one half of the width (w3).

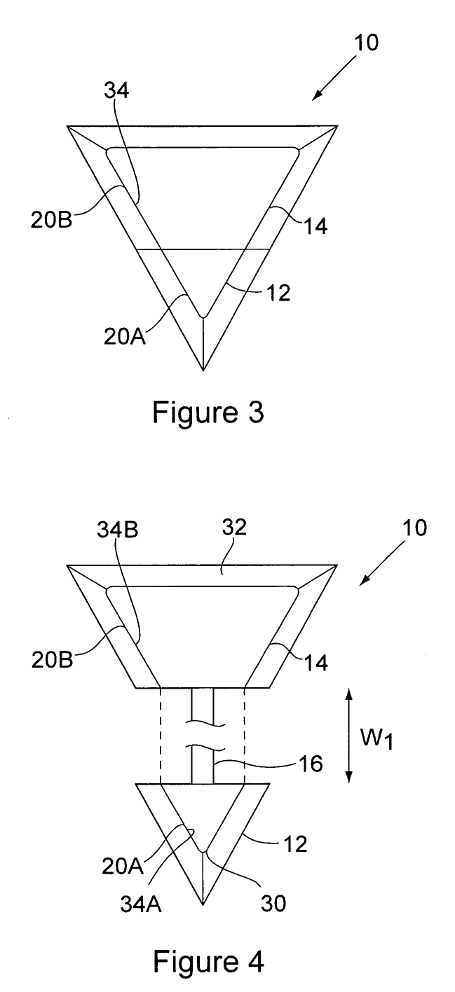

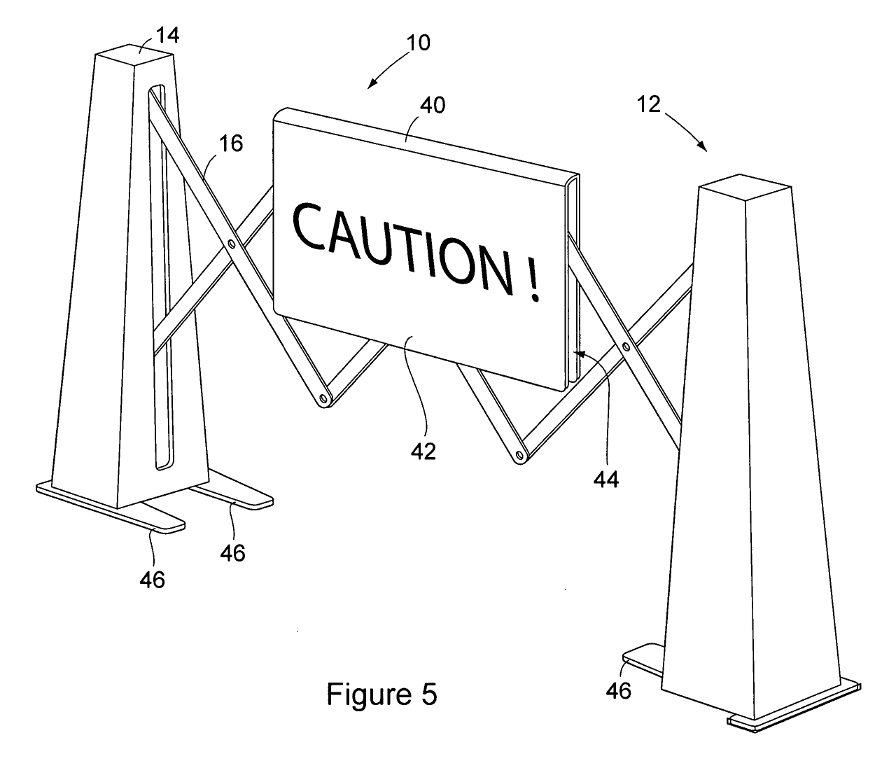

In other preferred embodiments, the surface portions 20A and 20B are canted at an acute angle relative to the expandable fence 16. For instance, FIGS. 3 and 4 show the cone-shaped sign 10 having a triangular cross section (when viewed from the top) with the portion 12 including an apex 30 of the cross section and the portion 14 containing the corresponding base 32 of the cross section. For the triangular sign 10, it is preferred that the fence 16 contract into the interior volume 18 in the base portion 14 where more space is available for storing the fence 18. Thus, the portion 14 can act as a storage volume for the expandable fence 16 with the portion 12 acting as a cover for the storage volume. In another preferred embodiment, the fence member is connected to one portion 12 and connectable to the other portion 14 such that the connected portion 12 (with the expandable fence member 16) and the connectable portion 14 can each be pre-positioned independently of the other. When a desire arises to use the sign 10 as a barrier, the expandable fence member 16 can be expanded and connected to the connectable portion 14.

FIGS. 3 and 4 also illustrate the flexibility of the signs provided by the present invention in that the two portions 12 and 14 need not have the same cross sections, or even symmetrical cross sections. Signs 10 having other cross sections are also provided by the present invention. One such exemplary sign has a circular cross section with a surface that can, of course, display messages in any direction relative to the expandable fence member 16. Other exemplary cross sections include hexagonal, octagonal, and even irregular cross sections.

With reference to FIG. 5, another preferred embodiment of the present invention is shown. Like the previous embodiments, the safety sign/barrier 38 of the present invention includes a first and a second portion, 12 and 14 respectively, of the support and an expandable fence member 16. In addition, the sign 38 includes a banner or additional display 40 that includes a display surface 42 and an aperture 44. The display surface 42 is, of course, for displaying messages and may be one side of a two-sided banner 40 (i.e. the display). The aperture 44 allows the display 40 to be draped over, slipped over, or otherwise attached to the expandable fence member 16 thereby increasing the number of display surfaces on the sign 38. While, an exemplary display 40 has been described as a banner, the present invention is not limited to such embodiments. Rather, many other types of displays (e.g. rigid displays) are included in the scope of the present invention.

In addition to illustrating the removable display 40, FIG. 5 also illustrates a preferred embodiment that includes stabilizers 46 (e.g. feet). The stabilizers 46 may aid in stabilizing the sign 38. Additionally, the sign 38 may include weights that attach to the bottom of one, or more support portions 12 and 14 to provide additional stability to the sign 38.

Further, either support portion 12 or 14 (or both) can provide connectors so that the expandable fence member 16 can be detached from the support(s). Thus, the sign 38 may be used, transported, or stored without the expandable fence member 16 and vice versa. Further, the fence member 16 can include connectors at one, or both, of its ends so that the fence member can be connected to support structures other than the support portions 12 and 14.

In view of the foregoing, it will be seen that the several advantages of the invention are achieved and attained. Generally, cone-shaped signs have been disclosed that can serve as barriers. As well, barriers that can serve as cone-shaped signs have been disclosed. Thus, time and effort will be saved as a result of having to obtain only the sign/barrier of the current invention when it becomes desirable to display a message and/or control access to an area. Further, barriers with increased display message areas have been provided. Also, barriers that stand on their own, even when in a contracted position have been provided.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. For example, handles could be included on the signs of the present invention to facilitate carrying the sign and expanding and contracting the expandable fence. Thus, the breadth and scope of the present invention should not be limited by any of the above-described exemplary embodiments, but should be defined only in accordance with the following claims appended hereto and their equivalents.

What is claimed is:

1. An expandable barrier, comprising:
an expandable fence member having a length with opposite proximal and distal ends, the fence member being adapted for expanding and contracting the fence member length;
a support including a first portion and a second portion, the expandable fence member being connected to the first portion of the support at the proximal end and being connected to the second portion of the support at the distal end, the support being adapted to maintain the expandable fence member in an upright, stable orientation when the expandable fence member is contracted; and
at least one display surface coupled to the expandable fence member and for displaying a message.

2. The expandable barrier according to claim 1, further comprising:
the display surface extending substantially parallel to the fence member length.

3. The expandable barrier according to claim 1, further comprising:
the display surface extending substantially perpendicular to the fence member length.

4. The expandable barrier according to claim 1, further comprising:
the first and the second portions of the support forming a cone-shaped sign when the expandable fence member is contracted.

5. The expandable barrier according to claim 1, further comprising:
a first portion of the display surface being on the first portion of the support and a second portion of the display surface being on the second portion of the support.

6. The expandable barrier according to claim 1, further comprising:
the at least one display surface further including four display surfaces arranged relative to one another to form a cone-shaped sign when the expandable fence member is contracted.

7. The expandable barrier according to claim 1 further comprising:
a width of the first portion being dimensioned to prevent the first portion from tipping over in response to a weight of the expandable fence member acting on the first portion.

8. The expandable barrier according to claim 1, further comprising:
the first portion and the second portion defining an internal volume, the expandable fence member being in the internal volume when the expandable fence member is in the contracted position.

9. The expandable barrier according to claim 1, wherein the support has a circular cross section.

10. A sign comprising:
a display surface for displaying a message and having a length; and
an expandable fence member having a length with opposite proximal and distal ends, the fence member being moveable along the fence member length to expand and contract the fence member between an expanded position and a contracted position, the fence member being coupled to and spaced apart from the display surface, the display surface length forming an angle relative to the fence member length that is less than 90 degrees.

11. The sign according to claim 10, further comprising:
a support including a first portion including a portion of the display surface and being connected to the proximal end of the fence member and a second portion including at least a portion of the display surface and being connected to the distal end of the fence member, the support being adapted to maintain the fence member in a stable, upright position regardless of the position of the fence member.

12. The sign according to claim 11, further comprising:
the first portion of the support and the second portion of the support forming a cone-shaped sign when the fence member is in the contracted position.

13. The sign according to claim 10, further comprising:
the display surface is a first display surface; and
a second display surface having a length that is perpendicular to the fence member length.

14. The sign according to claim 12, further comprising:
at least a portion of the cone shaped sign, including at least a portion of the display surface, and at least a portion of the cone shaped sign defining an interior volume, the fence member being in the interior volume when in the contracted position.

15. The sign according to claim 10, wherein the display surface is on a replaceable display panel.

16. An expandable barrier comprising:
a cone-shaped sign including a first portion and a second portion, the first portion having a first display surface with a length a second display surface with a width; and
a fence member having a length with opposite distal and proximal ends, the fence member being moveable along the fence member length to expand and contract the fence member between an expanded position and a contracted position, the fence member being connected to the first portion of the cone-shaped sign at the proximal end and being connected to the second portion of the cone-shaped sign at the distal end, the first display surface length being substantially parallel to the fence member length, the second display surface width being substantially perpendicular to the fence member length, the first and the second portions of the cone-shaped sign being adapted to maintain the expandable barrier in a stable, upright position when the fence member is in the contracted position.

17. A cone-shaped sign comprising:
a body having an interior volume and including a first portion and a second portion;
a plurality of display surfaces arranged around the body and for displaying a plurality of messages; and
an expandable fence in the interior volume and including a proximal end and an opposite distal end, the fence being moveable between a contracted position wherein the fence has a length that is minimized, and an expanded position wherein the fence has a length that is maximized, the fence being connected to the first portion of the cone-shaped sign at the proximal end and being connected to the second portion of the cone-shaped sign at the distal end, the first portion and the second portion of the cone-shaped sign generally abutting one another when the fence is in the contracted position.

18. The cone-shaped sign according to claim 17, further comprising:
a first portion of at least one display surface on the body first portion and a second portion of the at least one display surface on the body second portion, the first portion and the second portion of the at least one display surface being spaced apart when the fence is in the expanded position.

19. A barrier comprising:
an expandable fence having a variable length between a proximal end and a distal end, the fence being moveable between a contracted position wherein the variable length is minimized, and an expanded position wherein the variable length is maximized; and
a cone-shaped sign including a first portion and a second portion, the fence being connected to the first portion of the cone-shaped sign at the proximal end and being connected to the second portion of the cone-shaped sign at the distal end, the first and the second portions of the cone-shaped sign defining an interior volume, the expandable fence being in the interior volume when in the contracted position.

20. A sign comprising:
a body having a circular cross section, an interior volume, and including a first portion and a second portion;
a display surface around the body for displaying one or more messages; and
an expandable fence in the interior volume and including a proximal end and an opposite distal end, the fence being moveable between a contracted position wherein the fence has a length that is minimized, and an expanded position wherein the fence has a length that is maximized, the fence being connected to the first portion of the sign at the proximal end and being connected to the second portion of the sign at the distal end, the first portion and the second portion of the sign generally abutting one another when the fence is in the contracted position.

21. The sign according to claim 20 further comprising a first cross section of the first portion and a second cross section of the second portion, the first cross section being different than the second cross section.

22. An expandable barrier, comprising:
an expandable fence member having a length with opposite proximal and distal ends, the fence member being adapted for expanding and contracting the fence member length;
a support including a first portion and a second portion, the expandable fence member being connectable to the first portion of the support at the proximal end and being connected to the second portion of the support at the distal end, the support being adapted to maintain the expandable fence member in an upright, stable orientation when the expandable fence member is connected to the first portion; and
at least one display surface coupled to the expandable fence member and for displaying a message.

23. The expandable barrier according to claim 22, wherein the display surface is displaying a message.

24. The expandable barrier according to claim 22, further comprising a suction cup attached to a bottom of the support, the suction cup being adapted to aid in maintaining the expandable fence member in an upright, stable orientation when the expandable fence member is connected to the first portion.

25. An expandable barrier, comprising:
an expandable fence member having a length with opposite proximal and distal ends, the fence member being adapted for expanding and contracting the fence member length;
a support including a first portion and a second portion, the expandable fence member being removably connectable to the first portion of the support at the proximal end and being removably connectable to the second portion of the support at the distal end, the support being adapted to maintain the expandable fence member in an upright, stable orientation when the expandable fence member connected to the first and the second portions of the support and is contracted; and
at least one display surface coupled to the expandable fence member when the expandable fence member is connected to the first and the second portions of the support and for displaying a message.

26. The expandable barrier according to claim 25, further comprising a removable display surface adapted to fit over the expandable fence member.

27. A sign comprising:
a display surface for displaying a message and having a length; and
an expandable fence member having a length with opposite proximal and distal ends, the fence member being moveable along the fence member length to expand and contract the fence member between an expanded position and a contracted position, the fence member being removably coupled to the display surface, the display surface length forming an angle relative to the fence member length that is less than 90 degrees when the fence member is coupled to the display surface, the fence member being spaced apart from the display surface when the fence member is coupled to the display surface.

28. The sign according to claim 27, further comprising a removable display surface to fit over the expandable fence member.
